(19) United States
(12) Patent Application Publication
(10) Pub. No.: US 2025/0095631 A1
(43) Pub. Date: Mar. 20, 2025

(54) POSITION-BASED TEXT-TO-SPEECH MODEL

(71) Applicant: Adobe Inc., San Jose, CA (US)

(72) Inventors: Puneet Mathur, Sunnyvale, CA (US); Franck Dernoncourt, Spokane, WA (US); Quan Hung Tran, San Jose, CA (US); Jiuxiang Gu, Baltimore, MD (US); Ani Nenkova, Philadelphia, PA (US); Vlad Ion Morariu, Potomac, MD (US); Rajiv Bhawanji Jain, Falls Church, VA (US); Dinesh Manocha, Bethesda, MD (US)

(73) Assignee: Adobe Inc., San Jose, CA (US)

(21) Appl. No.: 18/528,116

(22) Filed: Dec. 4, 2023

Related U.S. Application Data
(60) Provisional application No. 63/583,446, filed on Sep. 18, 2023.

(51) Int. Cl. G10L 13/08; G10L 13/04; G10L 13/06; G10L 25/18

(52) U.S. Cl. CPC G10L 13/08; G10L 13/04; G10L 13/06; G10L 25/18

(57) ABSTRACT

Position-based text-to-speech model and training techniques are described. A digital document, for instance, is received by an audio synthesis service. A text-to-speech model is utilized by the audio synthesis service to generate digital audio from text included in the digital document. The text-to-speech model, for instance, is configured to generate a text encoding and a document positional encoding from an initial text sequence of the digital document. The document positional encoding is based on a location of the text encoding within the digital document. Digital audio is then generated by the text-to-speech model that includes a spectrogram having a reordered text sequence, which is different from the initial text sequence, by decoding the text encoding and the document positional encoding.

### RELATED APPLICATIONS

This application claim priority under 35 U.S.C. § 119 (e) to U.S. Provisional Patent Application No. 63/583,446 filed Sep. 18, 2023, Attorney Docket No. P12624-US, and titled “Position-based Text-to-Speech Model,” the entire disclosure of which is hereby incorporated by reference.

### BACKGROUND

Functionality available via machine-learning models continues to expand, from initial error correction and object recognition techniques to generative techniques usable to generate text, digital images, speech, and so forth. An example of this functionality is a text-to-speech model used to convert text inputs into speech. Optical character recognition systems, for instance, are employable to scan a physical document to arrive at a digital document that is then used as a basis to generate speech by the text-to-speech model.

A variety of technical challenges, however, are encountered in real world scenarios when attempting to implement text-to-speech. Conventional systems, for instance, are prone to error, are inaccurate, and hinder computing device operation when confronted with challenges caused by different document structures.

### SUMMARY

Position-based text-to-speech model and training techniques are described. A digital document, for instance, is received by an audio synthesis service. A text-to-speech model is utilized by the audio synthesis service to generate digital audio (e.g., as speech) from text included in the digital document. To do so, the text-to-speech model is configured to generate a text encoding and a document positional encoding from the digital document having an initial text sequence. The document positional encoding is based on a location of the text encoding within the digital document. Digital audio is then generated by the text-to-speech model that includes a spectrogram having a reordered text sequence, which is different from the initial text sequence, by decoding the text encoding and the document positional encoding.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ position-based text-to-speech model techniques for machine-learning models as described herein.

FIG. 2 depicts a system showing operation of a text layout encoder and a reading sequence decoder of a text-to-speech model of FIG. 1 in greater detail.

FIG. 3 depicts a system in an example implementation showing operation of a text encoding module and a location encoding module of a text layout encoder of FIG. 2 in greater detail.

FIG. 4 depicts a system in an example implementation showing operation of the reading sequence decoder of FIG. 2 in greater detail.

FIG. 5 is a flow diagram depicting an algorithm as a step-by-step procedure in an example implementation of operations performable for accomplishing a result of reordered digital audio generation by a text-to-speech model that is position based by leveraging knowledge of a digital document structure.

FIG. 6 illustrates an example system including various components of an example device that can be implemented as any type of computing device as described and/or utilize with reference to 1-5 to implement embodiments of the techniques described herein.

### DETAILED DESCRIPTION

### Overview

Text-to-speech (TTS) is a technique that leverages speech language processing by a computing device to convert text into digital audio, e.g., as speech to mimic a human being. Text-to-speech, for instance, is utilized to support human-machine interaction that is intelligible and indistinguishable from human speech and therefore increase richness in human interaction with a computing device. To do so, a text-to-speech model employs machine learning to train and retrain to the model recognize text inputs and convert the text inputs into digital audio for output by an audio output device, e.g., as spectrograms that are rendered for output as analog signals.

Conventional techniques used to implement text-to-speech, however, are confronted with numerous technical challenges that cause inaccurate results in real world scenarios. An example of one such technical challenge involves difficulties in addressing a structure of a digital document. Conventional text-to-speech systems, for instance, operate on an assumption that a reading order used to generate the digital audio is correct. The reading order is dependent on a structure of the digital document. However, conventional text-to-speech systems are incapable of inferring a structure in a digital document but instead rely on a preconfigured ordering as a “best guess” based on common structures that lacks accuracy in some examples.

Consider an example in which a digital document includes a plurality of cells that are staggered in relation to each other, which are also arranged in subsets having corresponding headers. An example of which is a schedule in which the cells have different sizes resulting in different amounts of text, with the cells arranged to describe different parts of the schedule, e.g., date, location, travel plans, directions, and so forth. A conventional text-to-speech technique implementing a “top-to-bottom” and “left-to-right” approach, for instance, has a relatively high likelihood of generating an output in which the order is unintelligible to a listener due to mismatches caused by the headers, different cell sizes, and so forth.

Accordingly, position-based text-to-speech model and training techniques are described that address these technical challenges. The text-to-speech model is configurable to synthesize digital audio (e.g., speech) directly from semi-structured documents, in which, an order of text recognized from the documents departs from a correct reading order due to a structure of the document.

The text-to-speech model, for instance, is configurable according to an encoder-decoder architecture that generates speech in an end-to-end manner given a document image, e.g., having optical character recognition (OCR) extracted text. The architecture is configurable to simultaneously learn text reordering and spectrogram generation (e.g., a Mel-spectrogram) in a multitask setup. Additionally, in one or more examples curriculum learning is leveraged to progressively learn sequences of text having increasing levels of complexity.

The text-to-speech model, for instance, is configurable using an end-to-end architecture that jointly supports document reading along with order sequence reordering, which differs from conventional separated approaches. The end-to-end architecture leads to a reduction in error accumulation due to multi-stage networks and backpropagation reduces errors encountered in reordering when performed jointly with generation of the spectrograms.

Additionally, simultaneous performance of reordering and spectrograms improves audio/text alignment, which increases accuracy and quality in the output of digital audio, e.g., through reduced unnatural pauses, appropriate pauses based on punctuations, and so forth. Further, the text-to-speech model is trainable to handle input sequences having increased lengths as compared with the fixed input size of the conventional models. These advantages improve output quality in support of naturalistic speech including pauses generated in response to line breaks and layout separations as further described below.

To do so in one or more examples, a digital document is received by an audio synthesis service. The digital document, for instance, is generated using optical character recognition by a device scanner to generate the digital document having text. Other examples are also contemplated, including use of a digital document that is generated directly by a computing device through text inputs received by the computing device.

A text-to-speech model is then utilized to generate digital audio (e.g., as speech) from text included in the digital document. The text-to-speech model, for instance, is configured to implement a task of document-level layout-informed text-to-speech synthesis to generate human-level speech having a correct reading order of text present in the digital document. The text-to-speech model implements a process to synthesize layout-informed speech for the digital document using machine learning by determining a reading order of the text jointly (e.g., simultaneously) for long-form digital audio generation.

The text-to-speech model, in at least one example, includes a text layout encoder and a reading sequence decoder. The text layout encoder is configured to receive phonemes (e.g., a smallest unit of sound in speech that is usable to distinguish one word from another) generated from text of the digital document. The text layout encoder is tasked with generating a text encoding as a numerical representation of the text.

As part of generating the text encoding, the text layout encoder is also configured to generate a document position encoding defining a relative spatial position of the text in the digital document, e.g., coordinates with respect to a page of the digital document. The document position encoding, in at least one example, is embedded as part of the text encoding. The text encoding is also configurable to include additional location encodings, e.g., defining a location of the text in relation to at least one other item of text in a text sequence.

The text encoding, having the embedded document position encoding, is then processed by the reading sequence decoder to generate digital audio (e.g., text) that is reordered from a sequence specified by the text received by the text layout encoder. As part of this processing, the reading sequence decoder also jointly generates the digital audio in the reordered sequence in at least one example, which improves performance as described above. As a result, the position-based text-to-speech model is configured to address technical challenges and increase accuracy. Further discussion of these and other examples is included in the following sections and shown in corresponding figures.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Machine Learning Knowledge Edit Environment

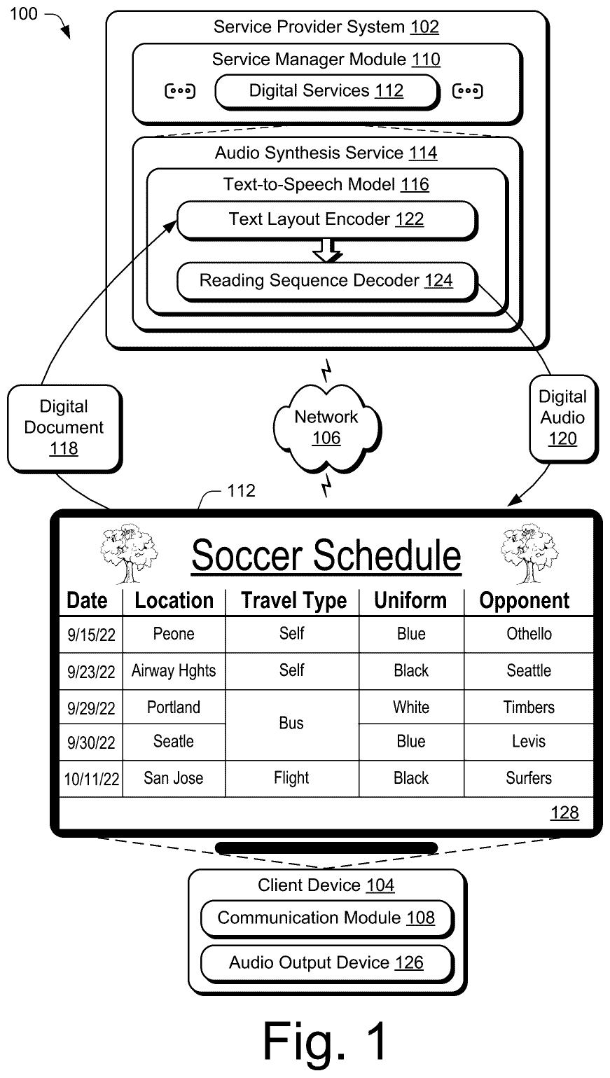

FIG. 1 is an illustration of a digital medium environment in an example implementation that is operable to employ position-based text-to-speech model techniques for machine-learning models as described herein. The illustrated environment 100 includes a service provider system 102 and a client device 104 that are communicatively coupled, one to another, via a network 106. Computing devices that implement the service provider system 102 and the client device 104 are configurable in a variety of ways.

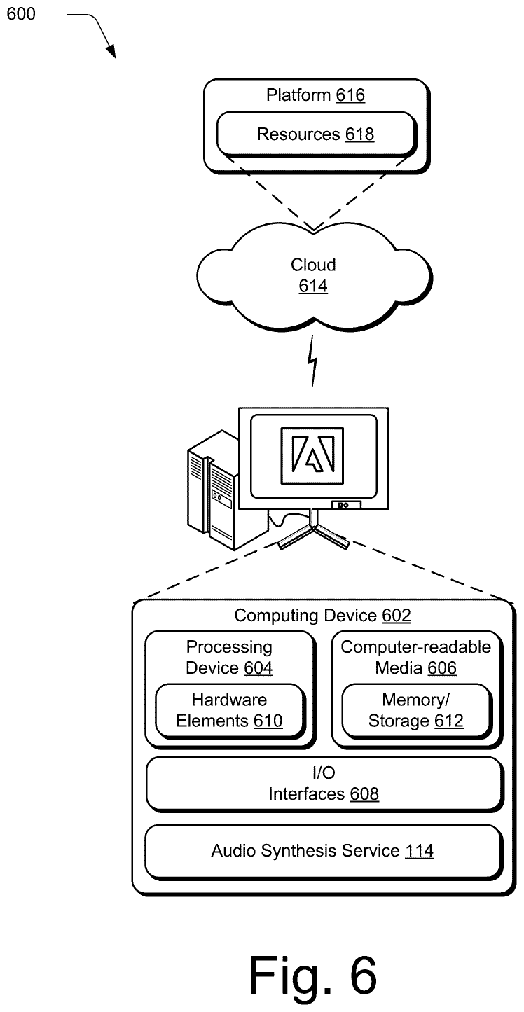

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is described in some examples, a computing device is also representative of a plurality of different devices, such as multiple servers utilized by a business to perform operations “over the cloud” as described in FIG. 6.

The client device 104 includes a communication module 108 that is representative of functionality to communicate via the network 106 with a service manager module 110 of the service provider system 102. The service manager module 110 is configured to implement digital services 112. Digital services 112 are usable to expose a variety of functionality to the client device 104, an example of which is illustrated as an audio synthesis service 114. The audio synthesis service 114 is configured to leverage a text-to-speech model 116 to employ machine learning to process a digital document 118 as an input and output digital audio 120 (e.g., text) as “reading” the digital document 118 in a structurally correct ordering. Although illustrated as implemented at the service provider system 102, the audio synthesis service 114 may also be implemented locally at the client device 104, e.g., as part of the communication module 108 as a application for local execution.

The text-to-speech model 116, for instance, is configurable as a neural network model having a plurality of layers formed using nodes. The text-to-speech model 116 is configured, in one or more examples, to jointly model text reading order detection as well as digital audio generation through spectrogram synthesis, e.g., Mel-spectrogram synthesis in which frequencies are defined using a Mel scale.

In the illustrated example, the text-to-speech model 116 does so using a transformer encoder decoder architecture implemented using a text layout encoder 122 and a reading sequence decoder 124. The text layout encoder 122, for instance, is configurable to generate a text encoding including document positional encodings that define a position within the digital document (e.g., a position on a page), at which, text that is subject of the text encoding is located. The text encoding is then used to generate digital audio as speech in this example that is reordered (e.g., with respect to a text sequence of the input) to address a structure of the digital document and associated text.

As illustrated in the user interface 128, for instance, text of a soccer schedule is shown in a table format that includes an overall title “Soccer Schedule” and is arranged into columns having respective headers for “date,” “location”, “travel type,” “uniform,” and “opponent.” The columns then include text that describe the corresponding subject matter in cells. In conventional text-to-speech techniques, the text would be read from top-to-bottom and left-to-right, which would cause a nonsensical output as a listener would be unaware as to which text values within the cells correspond to which headers, especially when confronted with staggered or shared cells as shown for “bus” as corresponding to multiple rows.

In the techniques described herein, however, the text-to-speech model 116 is configured to leverage knowledge of a structure of the digital document 118 to reorder the text sequence to generate the digital audio. In this example, the digital audio 120 is output to the client device 104 for rendering and output by an audio output device 126. As a result, the position-based text-to-speech model techniques overcome technical limitations of conventional techniques to improve digital audio 120 generation accuracy.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Position-Based Text-to-Speech Model

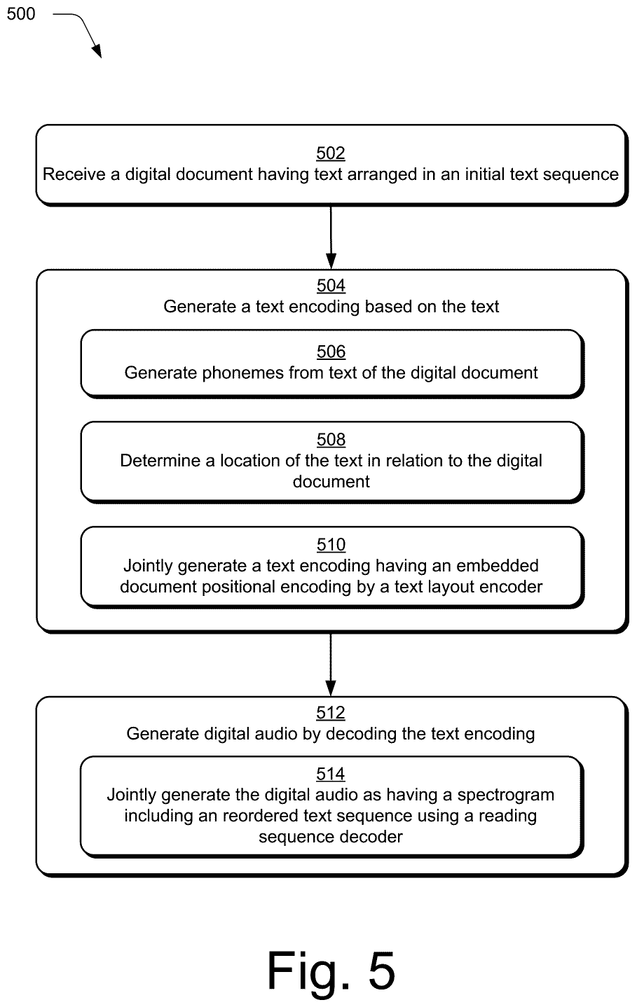

The following discussion describes position-based text-to-speech model techniques that are implementable utilizing the described systems and devices and performable without retraining of the model. Aspects of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. The following discussion includes discussion of the systems in parallel with operations of a flow diagram. FIG. 5, for instance, is a flow diagram depicting an algorithm 500 as a step-by-step procedure in an example implementation of operations performable for accomplishing a result of reordered digital audio generation by a text-to-speech model that is position based by leveraging knowledge of a digital document structure.

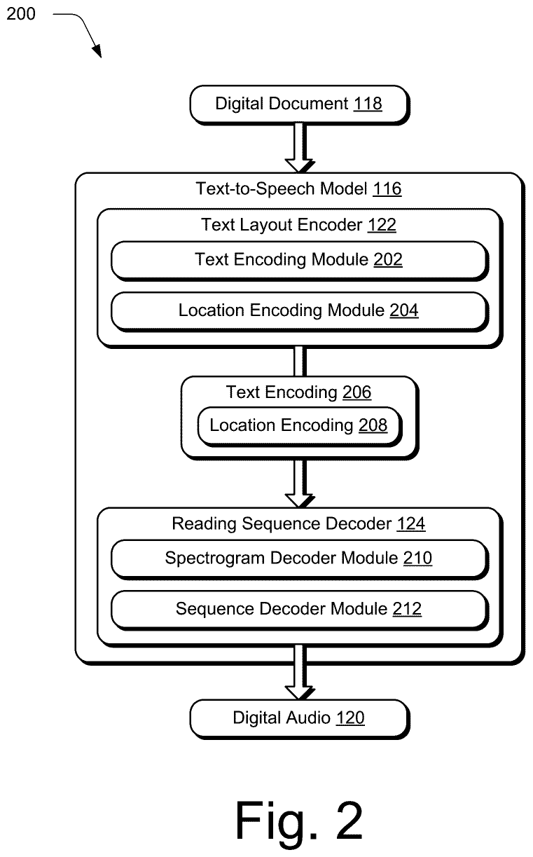

FIG. 2 depicts a system 200 showing operation of a text layout encoder and a reading sequence decoder of a text-to-speech model of FIG. 1 in greater detail. To begin in this example, a digital document 118 is received by a text-to-speech model 116. The digital document 118 includes text arranged in an initial text sequence (block 502). The digital document 118, for instance, is generated using optical character recognition from a scanned digital image of a physical document. In another instance, the digital document 118 is generated directly based on user inputs, e.g., via a keyboard using a word processor, email editor, and so forth.

The text-to-speech model 116 as previously described in relation to FIG. 1 includes a text layout encoder 122 and a reading sequence decoder 124. The text layout encoder 122 includes a text encoding module 202 and a location encoding module 204 that are configured to jointly generate a text encoding 206 having an embedded location encoding 208.

The text encoding 206 having the embedded location encoding 208 is then passed as an input to the reading sequence decoder 124 to generate the digital audio 120. To do so, the reading sequence decoder 124 includes a spectrogram decoder module 210 and a sequence decoder module 212 that are configured to jointly generate spectrograms having a reordered text sequence, i.e., in comparison with an initial text sequence of text as received by the text layout encoder 122.

In the following discussion the text layout encoder 122 is configured to perform a document-level layout-informed text-to-speech task. Given a semi-structured document “ [symbol] ” with words “w₂” (e.g., acquired through optical character recognition) and corresponding bounding box coordinates “(x₁, y₁, x₂, y₂)” where “(x₂, y₂)” are the top-left and bottom-right coordinates, respectively. The text layout encoder 122 is configured to synthesize spectrograms “ [symbol] ” such that constituent text is sorted into a correct reading order in digital audio, e.g., as a speech output.

In training of the text layout encoder 122 in one or more implementations, a ground truth reading order is derived from embedded extensible markup language (XML) metadata of respective digital documents. Further, the digital documents are converted into a portable document format to extract a two-dimensional bounding box of each item of text (e.g., word) used to define a respective location of the text within the digital document as a basis for generating the document positional encoding as further described below.

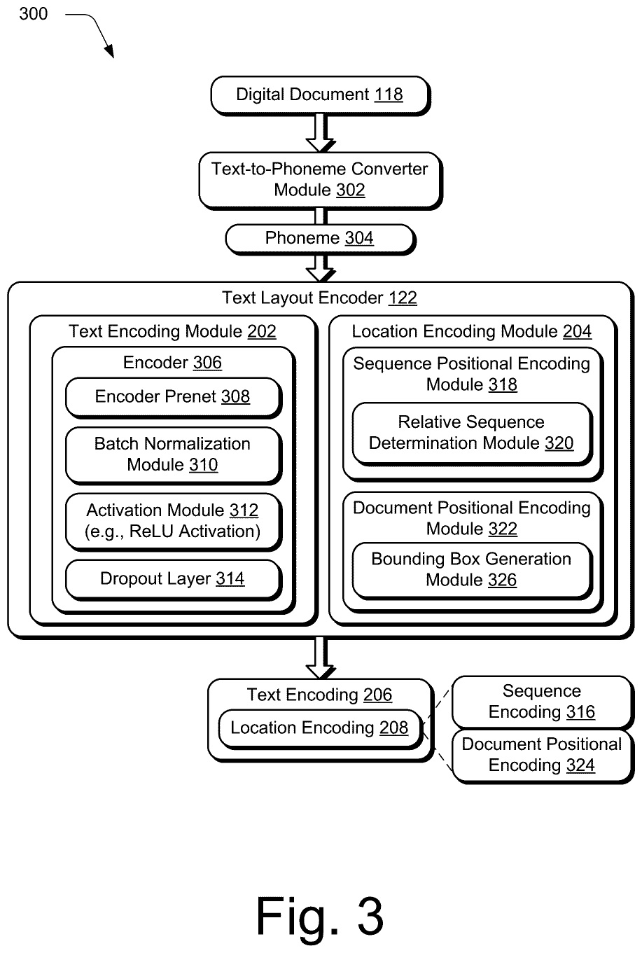

FIG. 3 depicts a system 300 in an example implementation showing operation of a text encoding module 202 and a location encoding module 204 of the text layout encoder 122 of FIG. 2 in greater detail. A text encoding is generated based on the text (block 504) of the digital document 118. In order to generate the text encoding 206, phonemes 304 are generated from text of the digital document 118 (block 506). A location of the text in relation to the digital document 118 is determined (block 508). A text encoding 206 is then generated, jointly, along with a document positional encoding 324 by a text layout encoder 122 (block 510).

In the illustrated example, the digital document 118 is received as an input by a text-to-phoneme converter module 302 to generate phonemes 304 based on text included in the digital document 118. Phonemes 304 are definable as a smallest unit of sound in speech that is usable to distinguish one word from another. The text-to-phoneme converter module 302, in one or more examples, is configured to normalize (e.g., convert numbers into words, expand abbreviations) and tokenize the text included in the digital document 118 to generate the phonemes 304. The text-to-phoneme converter module 302 is configurable in a variety of ways, examples of which include a grapheme-to-phoneme converter, use of a pre-trained machine-learning model (e.g., which may be included as part of the text layout encoder 122), and so forth.

In the illustrated example, the text encoding module 202 is configured to employ an encoder 306. The encoder 306 includes an encoder prenet 308 to embed the phoneme 304 input into a trainable embedding of five hundred and twelve dimensions, followed by a batch normalization using a batch normalization module 310, an activation module 312 (e.g., ReLU activation), and a dropout layer 314.

The text layout encoder 122 is also configured to employ the location encoding module 204 to generate the embedded location encoding 208 as part of the text encoding 206. In a first example, a sequence encoding 316 is generated through use of a sequence position encoding module 318. The sequence position encoding module 318 is configured to leverage a relative sequence determination module 320 to determine a location of the phonemes 304, respectively, in a sequence of text as a sequence encoding 316. The sequence encoding 316 “(PE),” for instance, is scaled by a factor of “a” to the processed phoneme 304 input to leverage knowledge of a position of a token in the relative token sequence. In other words, the sequence encoding 316 describes a relative position of text in relation to other items of text in the sequence.

A document positional encoding module 322 is also employed by the location encoding module 204 in the illustrated example. The document positional encoding module 322 is configured to generate a document positional encoding 324 based on a relative position of the text within the document, e.g., with respect to a page within the digital document 118. For example, the document positional encoding module 322 is configured to employ a bounding box generation module 326 to generate a bounding box based on the text, e.g., coordinates of the text associated with respective coordinate maximums and minimums along a respective axis. The document positional encoding 324 is then generated based on the coordinates.

The document positional encoding module 322, for instance, is configurable to add four two-dimensional positional encodings “(PEₓ_{₀}^{2D}, PEₓ_{₁}^{2D}, PE_{y}_{₀}^{2D}, P_{y}_{₁}^{2D})” to the phoneme 304 input for learning the relative spatial position in the digital document 118. For example, four two dimensional positional embedding layers correspond to an upper “(y₀),” lower “(y₁),” left “(x₀)” and right “(x₁)” coordinate directions, respectively, are used to define the relative location. Each input phoneme 304 “hᵢ”, therefore, as input to the text layout encoder 122 is representable by the following expression:

$${h}_{i} = prenet ( {phoneme}_{i} ) + α * P E ( i ) + β * ( P {E}_{{x}_{0}}^{2 D} ( i ) + {PE}_{{x}_{1}}^{2 D} ( i ) + P {E}_{{y}_{0}}^{2 D} ( i ) + P {E}_{{y}_{1}}^{2 D} ( i ) )$$

The text encoding 206 including the embedded location encoding 208 having the sequence encoding 316 and the document positional encoding 324 are then passed as an input to a reading sequence decoder 124 to generate digital audio 120 as further described below.

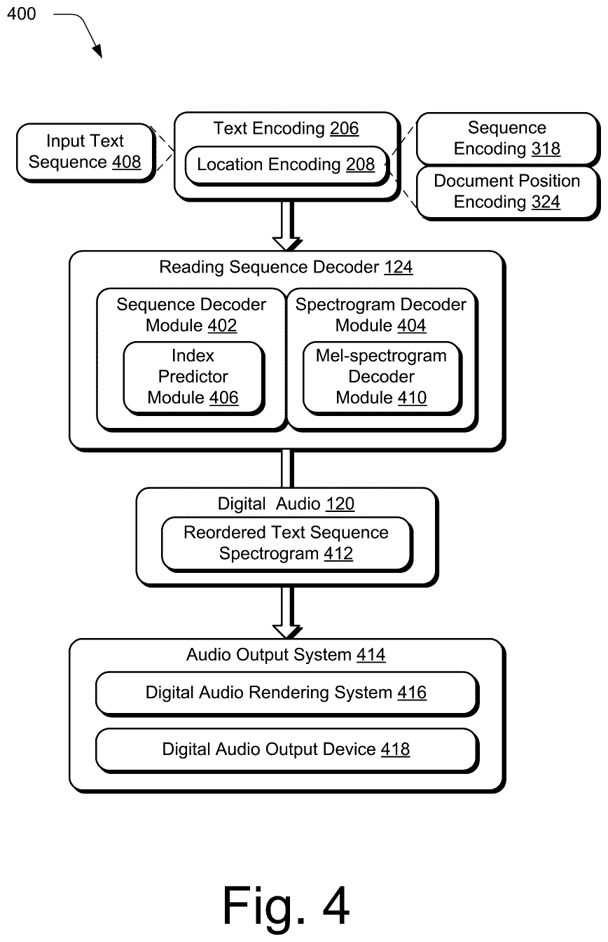

FIG. 4 depicts a system 400 in an example implementation showing operation of the reading sequence decoder 124 of FIG. 2 in greater detail. In this example, digital audio 120 is generated by decoding the text encoding 206 (block 512). To do so, a spectrogram is jointly generated as including a reordered text sequence using a reading sequence decoder 124 (block 514) that differs from an initial input text sequence 408 of the text encoding 206.

The reading sequence decoder 124, for instance, includes a sequence decoder module 402 and a spectrogram decoder module 404. These modules are configured to operate jointly as described above to generate the digital audio 120 as included a reordered text sequence spectrogram 412. To do so, the sequence decoder module 402 includes an index predictor module 406 and the spectrogram decoder module 404 includes a Mel-spectrogram decoder module 410.

In one or more implementations, in a sequence decoding stage of the reading sequence decoder 124, a source and target are reordered sequences. Target sequence prediction is constrained by the sequenced decoder module 402 to the correctly ordered indices in the source sequence. Additionally, the reading sequence decoder 124 is also configured to predict if a particular input position in the text encoding 206 and associated document positional encoding 324 indicates a break in the text, e.g., start of a newline in the digital document 118. To do so, binary classification is performed by the reading sequence decoder 124 as implemented as a classifier at each decoding step to classify whether a corresponding token denotes the break, e.g., as an end of a reading order line due to layout constraints, end of page width, and so on.

The Mel-spectrogram decoder module 410 is configurable as a transformer decoder using multi-head attention to integrate encoder hidden states in multiple perspectives. The Mel-spectrogram decoder module 410, in one or more examples, employs a larger embedding space of “d={1024,2048,4096}” compared to a five hundred and twelve embedding space of conventional text-to-speech models to better model long-range context vectors.

The reading sequence decoder 124, as described above, employs multi-task training to jointly learn the reordered text sequence spectrogram 412. In an example, mean absolute error (MAE) is used as part of predicting the spectrogram, e.g., a Mel-spectrogram. Reordered sequence index classification uses categorical cross-entropy loss, while newline prediction uses a weighted binary cross-entropy loss to adjust for class imbalance. Each of these three tasks are correlated and reinforce each other, so multi-task training may be performed utilizing simultaneous optimization. The final optimization, in one or more examples, uses a weighted sum of the link prediction loss and element classification loss where the weighting factors “λ” and “γ” are hyperparameters as shown in the following Equation:

$${L}_{t otal} = λ {L}_{mel} + γ \vert {L}_{r e o r d e r} + ( 1 - λ - γ ) {L}_{n ewline}$$

In this above example, the three losses are summed, however other examples are also contemplated, e.g., two of the three losses may be summed. The digital audio 120 having the reordered text sequence spectrogram 412 is then received as an input by an audio output system 414 to output the digital audio 120, e.g., for listening by a human being. To do so, a digital audio rendering system 416 is configured to render the spectrograms which are then output by a digital audio output device 418, e.g., speakers.

Returning again to FIG. 2, in one or more implementations curriculum learning is employed by the text layout encoder 122 to improve the training process for the machine-learning model. Curriculum learning is a deep learning training process where the difficulty and complexity of learning increases over successive iterations. Accordingly, curriculum learning is used in this example to train the encoder-decoder network of the text layout encoder 122 and reading sequence decoder 124 to help generate longer sequence inputs without losing long-range context.

The text-to-speech model 116, for instance, initially starts with a sentence level input. In the subsequent iterations, the text-to-speech model 116 is trained using document text with increasing lengths. In order to address scenarios involving limited graphics processing unit (GPU) capacity, the text-to-speech model 116 is set to automatically reduce a batch size to one half whenever a GPU capacity limit is reached.

Accordingly, the text-to-speech model 116 as described above is configurable to synthesize digital audio (e.g., speech) directly from semi-structured documents, in which, an order of text recognized from the documents departs from a correct reading order due to a structure of the document.

The text-to-speech model, for instance, is configurable according to an encoder-decoder architecture that generates speech in an end-to-end manner given a document image. The architecture is configurable to simultaneously learn text reordering and spectrogram generation (e.g., a Mel-spectrogram) in a multitask setup. Further, curriculum learning is leveraged in one or more examples to progressively learn sequences of text having increasing levels of complexity.

The text-to-speech model is configurable using an end-to-end architecture that jointly supports document reading along with order sequence reordering, which differs from conventional separated approaches. The end-to-end architecture leads to a reduction in error accumulation due to multi-stage networks and backpropagation reduces errors encountered in reordering when performed jointly with generation of the spectrograms.

Additionally, simultaneous performance of reordering and spectrograms improves audio/text alignment, which increases accuracy and quality in the output of digital audio, e.g., through reduced unnatural pauses, appropriate pauses based on punctuations, and so forth. Further, the text-to-speech model is trainable to handle input sequences having increased lengths as compared with the fixed input size of conventional models. These advantages improve output quality in support of naturalistic speech including pauses generated in response to line breaks and layout separations.

### Example System and Device

FIG. 6 illustrates an example system generally at 600 that includes an example computing device 602 that is representative of one or more computing systems and/or devices that implement the various techniques described herein. This is illustrated through inclusion of the audio synthesis service 114. The computing device 602 is configurable, for example, as a server of a service provider, a device associated with a client (e.g., a client device), an on-chip system, and/or any other suitable computing device or computing system.

The example computing device 602 as illustrated includes a processing device 604, one or more computer-readable media 606, and one or more I/O interface 608 that are communicatively coupled, one to another. Although not shown, the computing device 602 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 604 is representative of functionality to perform one or more operations using hardware. Accordingly, the processing device 604 is illustrated as including hardware element 610 that is configurable as processors, functional blocks, and so forth. This includes implementation in hardware as an application specific integrated circuit or other logic device formed using one or more semiconductors. The hardware elements 610 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 606 is illustrated as including memory/storage 612 that stores instructions that are executable to cause the processing device 604 to perform operations. The memory/storage 612 represents memory/storage capacity associated with one or more computer-readable media. The memory/storage 612 includes volatile media (such as random access memory (RAM)) and/or nonvolatile media (such as read only memory (ROM), Flash memory, optical disks, magnetic disks, and so forth). The memory/storage 612 includes fixed media (e.g., RAM, ROM, a fixed hard drive, and so on) as well as removable media (e.g., Flash memory, a removable hard drive, an optical disc, and so forth). The computer-readable media 606 is configurable in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 602. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 602, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 610. The computing device 602 is configured to implement particular instructions and/or functions corresponding to the software and/or hardware modules. Accordingly, implementation of a module that is executable by the computing device 602 as software is achieved at least partially in hardware, e.g., through use of computer-readable storage media and/or hardware elements 610 of the processing device 604. The instructions and/or functions are executable/operable by one or more articles of manufacture (for example, one or more computing devices 602 and/or processing devices 604) to implement techniques, modules, and examples described herein.

The techniques described herein are supported by various configurations of the computing device 602 and are not limited to the specific examples of the techniques described herein. This functionality is also implementable all or in part through use of a distributed system, such as over a “cloud” 614 via a platform 616 as described below.

The cloud 614 includes and/or is representative of a platform 616 for resources 618. The platform 616 abstracts underlying functionality of hardware (e.g., servers) and software resources of the cloud 614. The resources 618 include applications and/or data that can be utilized while computer processing is executed on servers that are remote from the computing device 602. Resources 618 can also include services provided over the Internet and/or through a subscriber network, such as a cellular or Wi-Fi network.

The platform 616 abstracts resources and functions to connect the computing device 602 with other computing devices. The platform 616 also serves to abstract scaling of resources to provide a corresponding level of scale to encountered demand for the resources 618 that are implemented via the platform 616. Accordingly, in an interconnected device embodiment, implementation of functionality described herein is distributable throughout the system 600. For example, the functionality is implementable in part on the computing device 602 as well as via the platform 616 that abstracts the functionality of the cloud 614.

In implementations, the platform 616 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, a digital document having text arranged in an initial text sequence;
generating, by the processing device, a text encoding and a document positional encoding from the digital document, the document positional encoding is based on a location of the text encoding within the digital document; and
generating, by the processing device, digital audio including a spectrogram having a reordered text sequence, which is different from the initial text sequence, by decoding the text encoding and the document positional encoding.

2. The method as described in claim 1, wherein the document positional encoding is based on coordinates defined in relation to a page of the digital document.

3. The method as described in claim 1, wherein the document positional encoding is based on a bounding box defined for the text.

4. The method as described in claim 3, wherein the document positional encoding includes four two-dimensional positional encoding defining a relative spatial position of the text within the digital document.

5. The method as described in claim 1, wherein the generating includes embedding the document positional encoding as part of the text encoding.

6. The method as described in claim 1, wherein:
the generating the text encoding and the document position encoding is performed by a text layout encoder of a text-to-speech model using machine learning; and
the generating the digital audio including the spectrogram having the reordered text sequence is performed using a reading sequence decoder of the text-to-speech model using machine learning.

7. The method as described in claim 6, wherein the text-to-speech model is trained using curriculum learning.

8. The method as described in claim 6, wherein the generating the text encoding and the document position encoding is performed jointly by the text layout encoder.

9. The method as described in claim 6, wherein the generating the digital audio including the spectrogram having the reordered text sequence is performed jointly using the reading sequence decoder.

10. The method as described in claim 1, wherein the generating the text encoding further comprises generating a text sequence positional encoding as part of the text encoding, the text sequence positional encoding defining a position of the text encoding within a text sequence of the digital document.

11. The method as described in claim 1, wherein the generating includes converting the text from the digital document into a phoneme and wherein the text encoding is generated based on the phoneme.

12. The method as described in claim 1, wherein the generating the digital audio includes classifying whether the document position encoding indicates a break in the digital document.

13. A system comprising:
a text-to-phoneme converter module implemented by a processing device to convert text in a digital document into a plurality of phonemes; and
a text-to-speech model implemented by the processing device to convert the plurality of phonemes into digital audio using machine learning, the text-to-speech model including:
a text layout encoder to generate a plurality of text encodings based on the plurality of phonemes using machine learning, the plurality of text encodings having embedded, respectively, a document positional encoding based on a location of a respective said text encoding within the digital document; and
a reading sequence decoder to decode the plurality of text encodings into the digital audio.

14. The system as described in claim 13, wherein the reading sequence decoder is configured to generate reordered text sequence in the digital audio which is different from an initial text sequence of the plurality of phonemes.

15. The system as described in claim 14, wherein the reading sequence decoder is configured to generate the digital audio as including a spectrogram having the reordered text sequence.

16. The system as described in claim 13, wherein the document positional encoding is based on coordinates defined in relation to a page of the digital document.

17. The system as described in claim 13, wherein the text layout encoder is further configured to generate a text sequence positional encoding as part of the text encoding, the text sequence positional encoding defining a position of the text encoding within a text sequence of the digital document.

18. The system as described in claim 13, wherein the reading sequence decoder is further configured as a classifier to determine whether a respective said document positional encoding associated with a respective said text encoding indicates a break in the digital document.

19. One or more computer readable storage media storing instructions that, responsive to execution by a processing device, causes the processing device to perform operations including:
receiving a digital document having text; and
generating digital audio based on the digital document, the digital audio including a spectrogram having a reading order generated jointly by a text layout encoder and a reading order sequence decoder of a text-to-speech model.

20. The one or more computer readable storage media as described in claim 19, wherein the text-to-speech model is trained using curriculum learning.
